(19) United States
(12) Patent Application Publication
(10) Pub. No.: US 2015/0102098 A1
(43) Pub. Date: Apr. 16, 2015

(54) SYSTEM AND METHOD FOR VIEWING SEALED COLLECTIBLES

(71) Applicant: Darren Phillip Adams, Kent, WA (US)

(72) Inventor: Darren Phillip Adams, Kent, WA (US)

(21) Appl. No.: 14/514,291

(22) Filed: Oct. 14, 2014

Related U.S. Application Data
(60) Provisional application No. 61/890,194, filed on Oct. 12, 2013.

(51) Int. Cl. G06F 17/30; H04L 29/08

(52) U.S. Cl. CPC G06F 17/30017; H04L 67/1097
USPC 235/375

(57) ABSTRACT

A system and method for providing audio and visual access to images of an item stored within a protective case includes a code, address, or other indicator directing a user to a location where images of the stored item can be found. The code may include a URL for a particular website or a bar code, QR code, or other scannable or accessible code to direct a user to the location having the images. In some versions, the stored images of the protected item may amount to a digital “tour” of the stored item.

### PRIORITY CLAIM

This application claims the benefit of prior U.S. provisional application No. 61/890,914 filed Oct. 12, 2013, the contents of which are incorporated by reference.

### FIELD OF THE INVENTION

This invention generally relates to interactive systems for viewing the content of collectible items sealed within a protective container.

### BACKGROUND OF THE INVENTION

Collectibles goods such as comic books, text books, and magazines hold value based on condition. Overall condition is often rated on a point system, for example on a scale of 0-10. Grading is scored on several factors including the conditions of the interior and exterior of the particular collectible item.

Industry practices include sending material to a grading company for rating and authentication. Traditional grading processes include a panel of experts reviewing the entire body of work submitted cover to cover to create an “average” or “mean” to reflect a consensus of condition of the submitted item. Once a work has been graded it is often then sealed inside a plastic case to prevent any damage to the valuable collectible work, while a final grade related to the item is noted on the outside of the plastic casing. Defects of the interior as well as exterior of the item are often noted by those who graded the item with those comments used for internal records and often times available for others to have access to them. The ability to visually see these defects (or to visually see the absence of such defects) can validate the grader's opinions and allow a person to formulate their own judgment.

Current grading methods leave much to be desired for interior documentation. After encapsulation the end consumer is unable to verify and concur with a grading company findings due to the inability to access the interior of material without compromising tamper proof seals provide by various grading companies. The inability to personally verify condition potentially hinders trust between buyer, seller, and grading company.

The standards and practices within the grading system inhibits inspection by all parties to verify authenticity, historical record, interior condition and other key traits only accessible via personal interaction. Traditional methods rely on trust of seller without the ability to quantify finding. The attributes of the current grading system do not deter fraud due to the lack of accountability of graded material, the ease with which it is possible to forge available documentation, and the lack of verification of the interior's appearance. In addition to the inability to identify characteristics of the encased item such as its perfection or imperfection, there is an inability to simply see and enjoy the item because it is locked within a protective case.

### SUMMARY OF THE INVENTION

The present invention relates to a system and method for providing audio and visual access to images of an item stored within a protective case.

In one version of the invention, the protective case includes a code, address, or other indicator directing a user to a location where images of the stored item can be found, such as a URL for a particular website or a bar code, QR code, or other scannable or accessible code to direct a user to the location having the images.

In some versions, the stored images of the protected item may amount to a digital “tour” of the stored item. Distribution of digital tours can be made available through traditional and non-traditional media such as cloud computing systems, email, social networking, compact disk, and any other form of media that can capture the content of the item. Thus, in various versions of the invention an indicator visible on or within the case can direct the user to the location or manner in which the user can access the digital tour or other audio/visual descriptors and images.

The intentions of video guided tours is to provide tangible documentation and historical record of graded material for referencing, quality control, and digital recognition of graded and/or collectible items prior to encapsulation and other forms of limited access. Items suitable for digital tours include but not limited to comic books, trading cards, text books, magazines, pamphlets, flyers, advertisements, novels and other physical goods where value is subjected to interior and exterior conditions but personal inspection and/or handling is restricted and/or limited.

Many collectors enjoy the idea of having their items graded and sealed in casing, but do not pursue it because once it is processed and encased they have lost the ability to see and enjoy the collectible item. Some collectors would strongly prefer to be able to see the internal object, including the sealed pages that are otherwise not visible or accessible, for example to simply read the book, to admire a particular feature (including a certain defect), or to see a name or an autograph that may be hidden inside.

The images of the interior of the collectible item may further include images of particular features, such as a signature or autograph. In some cases an author or other person may autograph a collectible item, and that autograph may appear on an inside page within a stored collectible having multiple pages. Indeed, historically it has been common practice to sign books on an inside page of the book. Preferably the audio/visual information includes an image (whether still or moving video) an autograph page, thereby allowing users to see the autograph. Most preferably, the image of the autograph is sufficiently clear that the autograph may be authenticated by the audio/visual information.

For the company formulating the video or grading the item, the various embodiments of the invention offer additional income streams in the form of still shot or video imagery fees, data hosting, advertising opportunities, branding, marketing, all of which can now be implemented by watermarks, editing, or otherwise visually infused to the still or video imagery. Thus, in some versions of the invention a fee may be charged before the user is allowed to proceed with viewing the stored item. In this fashion, the item and the indicator on the case provides a gateway for unlimited possibilities otherwise previously not possible before this technology.

Retrieval of videos or stored images shall be made available in a variety of fashions, including but not limited to traditional and non-traditional tracking and retrieving systems such as QR codes, barcodes, URL's and/or any other form of encrypted or unencrypted identification methods.

The intention of digital tours of the interior of collectibles is to offer consumers the opportunity to investigate the true condition of material after encapsulation, thereby taking advantage of the aforementioned features, characteristics and benefits along with any and all marketable attributes provided by this service. The process enables consumers to view, watch, and agree to the status of the graded item before and after sealing item into tamper proof containers. The process is revolutionary to the industry. To date there is no service/ability to fully document the interior of items after grading has been established and access has been restricted.

In some versions of the invention, users may grade the item after viewing the images of the stored and graded item. A computing system can aggregate the grades of the users over time, providing a collective user grade in addition to one or more grades issued by professional grading services. These user grades can also be made visible by accessing the stored audio/visual information related to the inside of the collectible item.

The addition of video tours will influence the overall rating of items and allow for a deeper understanding of the grading process. Furthermore, collectors of truly rare items will now have the ability to showcase an items substance like never before. Collectors and consumers will benefit from being able to access priceless material without compromising integrity. The addition of digital tour documentation will add validly to the rating system while introducing consumers to parts of material previously unobtainable.

### BRIEF DESCRIPTION OF THE DRAWINGS

Preferred and alternative examples of the present invention are described in detail below with reference to the following drawings.

FIG. 1 is a perspective illustration of a preferred collectible item shown in a case and having one or more labels for directing users to audio and/or visual information related to the stored item.

FIG. 2 is a block diagram of a preferred system for enabling access to stored audio/visual information for a collectible item.

FIG. 3 is a screen display at a representative computing terminal for a presentation of audio/visual information related to an encased collectible item.

FIG. 4 is an illustration of a representative mobile device, presenting audio/visual information of the type illustrated in FIG. 3.

### DETAILED DESCRIPTION OF THE PREFERRED EMBODIMENT

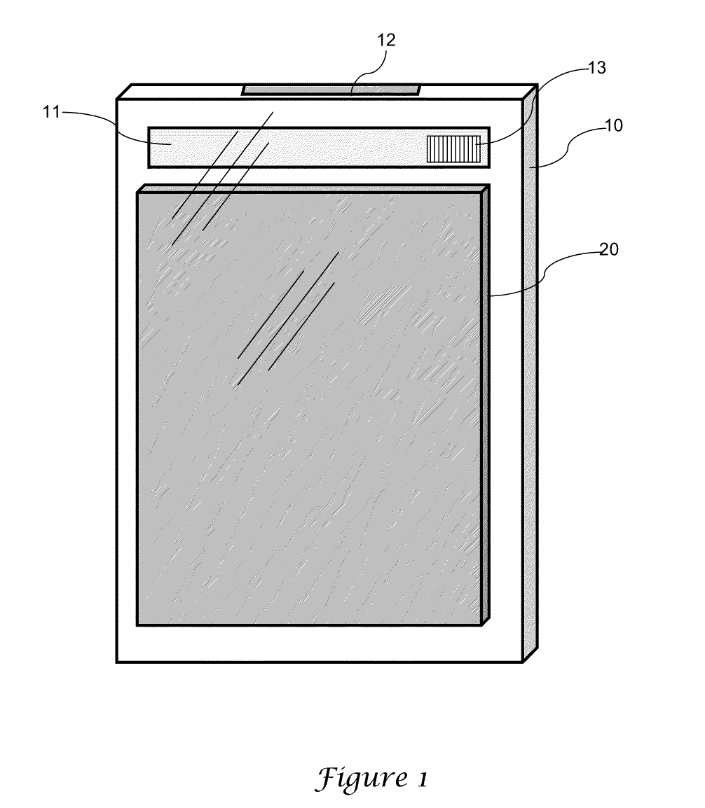

A collectible item may include, for example, a comic book 20 as illustrated in FIG. 1. Other items such as trading cards, hardcover books, or yet other collectibles may also be the subject of the present invention. In general, the collectible item is one that is suitable for storage in a protective case in order to protect the collectible item. In many cases, the collectible item is graded by an entity such as a professional grading organization, assigning a grade or score to the item as an indication of the condition of the item.

After a collectible is graded, it may be sealed in a case 10, and in the illustrated version the case may be clear to allow users to view the outer cover of the book or other collectible. For example, the case may be formed from acrylic, polycarbonate, or other materials allowing others to see the item within the case. Typically, however, the case is sealed and cannot be opened without destroying the case or leaving evidence that it has been opened or tampered with. The case may include labels 11, 12, providing information about the collectible, such as the grade, title, or other information.

At a location visible on the case, a code 13 is provided. The code provides a means for enabling persons to access more information about the collectible, preferably including images of the pages within the book that are otherwise inaccessible. The code may be a QR code, bar code, or other such graphical or iconic image that can be read or decoded in order to associate the code with the encased collectible. In other forms, the code need not be literally encoded or encrypted, but may take the form of a URL, UBI, or other indicator enabling a user to access the additional information. The code may also be an address, phone number, or other indicator allowing the user to obtain the additional information.

Most preferably, the additional information is electronic in form, residing on a remote computer or remote server that is accessible by a user who initiates a request for the information via the code (or through other independent channels, in alternate versions of the invention).

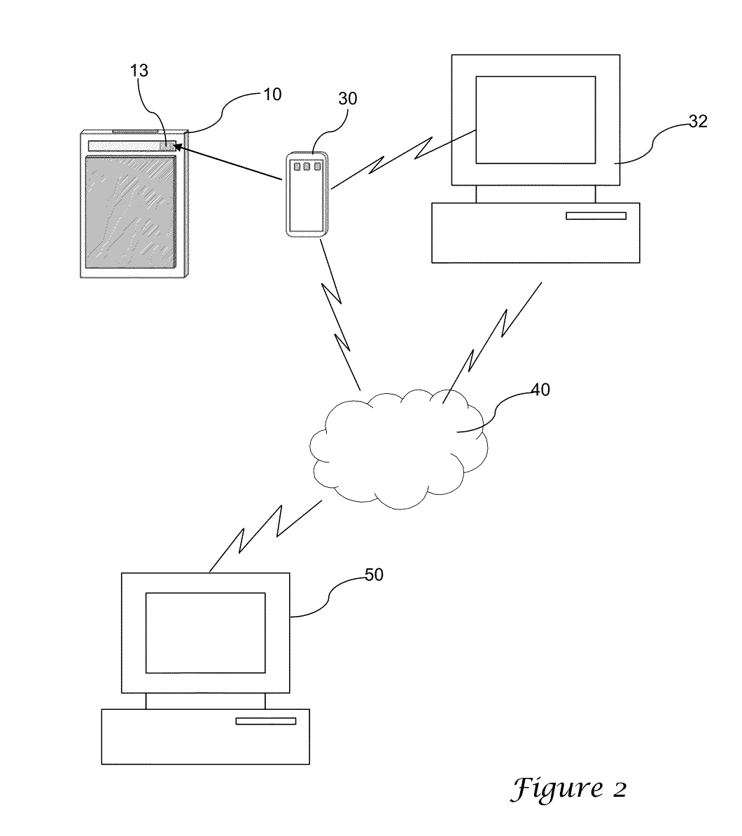

In one example, as illustrated in the block diagram of FIG. 2, a user scans the code 13 on the case 10 using a hand-held scanner, smart phone, or other device 30. In this example, the code is an optically readable code such as a QR or bar code, with such codes being accessible using the camera sensor on a smart phone. An application program running on the smart phone deciphers the code and accesses a remote computer. In various embodiments, the remote computer may be accessed over the internet, through a WiFi connection, via cell or other communications channels.

The application on the smart phone ultimately accesses a remote computer 50, in which the remote computer contains the additional information related to the collectible item. The remote computer 50 may be a remote server in communication with the scanner or other hand-held computing device 30, and may further be in communication with a local computer 32 for accessing the same remote server 50.

In an alternate version, the code is human-readable, such as with a URL or an alphanumeric code. In such versions, the user may enter the URL or other code into an appropriate application on a computer (such as by using a browser) to access the information on the remote computer.

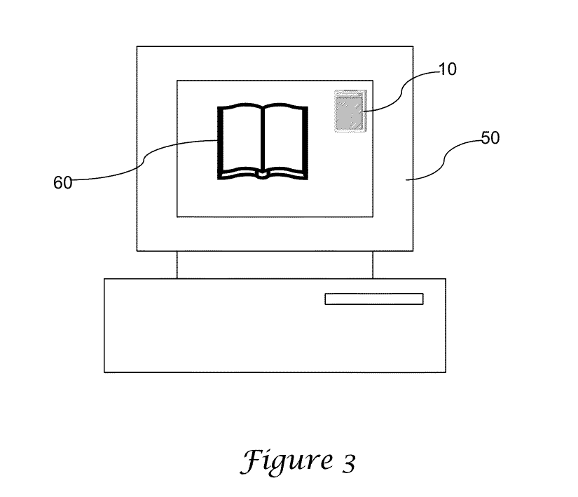

In the preferred example, accessing the remote computer causes the remote computer to send visual images of the collectible to the smart phone or other client computing device. For example, as illustrated in FIG. 3, the computing system 50 may present on a display an image of the encased collectible item 10 together with the visual display of the inside 60 of the book. Alternatively, or in addition, the local computer 50 may play audio accompanying the display, and may depict a name of the book, grading information, or other historical or trivial information about the book.

In one version the additional information is in the form of a plurality of images of pages of the collectible item (when the item is a book), allowing the user to view each of the individual pages that are otherwise inaccessible. In one example, the additional information is in the form of a video depicting the internal pages of the book. Thus, for example, the video may be a video in which the individual pages of the book are turned one at a time, allowing a user watching the video to see each of the pages within the book. The pages may be linked to an index at the start of the video, allowing a user to select a particular page (such as via a hyperlink) right away rather than viewing each of the pages sequentially. The video may further be enhanced as desired by setting it to music, being accompanied by a voice reading words on the applicable pages, or by other additional content.

In yet other versions, the application program (for example, running or otherwise hosted by the remote computer) may include an interface allowing the user to advance forward or backward within the book, as with turning pages in the book itself. As noted above and illustrated in FIG. 3, the presentation to the user may include a view of the pages 60 of the book, and may optionally further include an image of the collectible item 10 as shown within the case, thereby giving the user a visual confirmation that he or she is evaluating the actual pages associated with the correct item.

In one embodiment, the images or video are time-stamped, with a presentation to the user on the display with the time stamp (or other form of displaying the dates or times). Most preferably, the user is provided with date information indicating to the user the dates upon which the visual page information was recorded, thereby allowing the user to further evaluate the age of the images and the potential that the collectible remains in the same shape as when the images were taken. In the event a collectible has been photographed or video-recorded on multiple occasions, the user can be presented with each of the plurality of recordings and images to allow the user to evaluate any changes over time, and further to ensure that the user is viewing images conveying the most recent condition of the collectible.

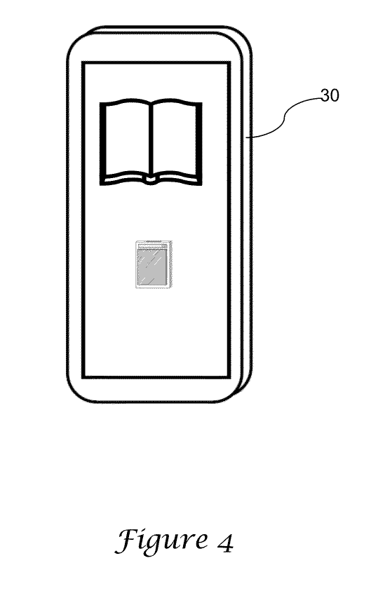

In the above versions, the display is preferably presented on a computer or smart phone, in the form of presentation through a browser on either the computer or phone, such as is illustrated in FIG. 4. In other versions, the remote computer may send the images to the user as a separate file, such as by text message, as an email attachment, or in another form. In one example of such an embodiment, the user may access the remote server and then will be prompted for an email address, phone number, or other such information to enable the remote computer to transfer the file directly.

In another embodiment, the user can access the remote computer directly and is prompted to enter a code in order to isolate corresponding video documentation designated to accompany a particular item. The user may also browse through the collection and be provided with corresponding codes, allowing the use to later look for the actual collectible corresponding to videos that were considered to be worthwhile. In one such version, a server may include any number of audio/visual files for graded collectible items, allowing users to search through a catalog of files by type, name, or other means. Users may then view the audio/visual files and evaluate the particular collectible item. The files preferably include an indicator or code with the audio/visual file, or other identifying information allowing the user to determine whether the item is for sale and the location of the owner in order to consider a purchase of the item.

Productions copies can also be offered as compact disc, MP3 format and Cloud sharing in order to allow users to obtain the audio/visual files.

Video guided tours of interior of collectible items shall reflect the true condition of areas of items regularly invisible to consumers. Video will include documentation of material cover to cover including all text, images, inserts, and so on that encompasses the work. Video documentation will be held as a form of record to quantify grades and offer current and potential consumers the opportunity to personally verify interior condition.

Additionally as technology advances, and as now, there will be opportunity for video feed of still shot images to come alive, or animate into action as facial and image recognition develops. Having access to archived video or still shot footage of the actual collectible preserves the ability gain access to this technology.

Video documentation provided by credible grading companies can be incorporated as a form of historical record and visual authenticity to further efforts to eliminate forged and stolen items. Videos thereby act as an added amenity for collectors so long as the video tour is professionally produced and endorsed by accredited sources such as CGC (Certified Guarantee Corporation) and PGX (Professional Grading Experts). Thus, in preferred versions of the invention the grading information is paired with the labels on the case, the videos, or both.

Implications are not limited to verifying the legitimacy of items but also to manufacture digital counterparts engineered to increase notoriety. Combining tactics such as celebrity narrations, interactive features, creator's comments, music and other similar means limiting mass digital production while driving demand can be incorporated to influence market share and consumers' expectations for the collectibles items digital counterparts.

Particularly in examples in which the stored audio/visual information is accessible on a server computer, the server may include stored programming instructions inviting users to grade the item after seeing the audio/visual information. The programming instructions may aggregate the user grades over time, and present an aggregate user grade along with the professional grade for the item. The aggregate grade may be in the form of an average or mean of the user grades, and in some versions it may disregard outlier grades such as those that are unusually low or high. It may similarly discount or ignore grades that are outside of a preset range that is determined to be an acceptable grade range for the collectible item. In yet another version, the server may track IP addresses or other information for users and prevent single users from grading the item more than once.

Digital tours of interiors are preferably linked to their rightful collectible via encrypted identification and other forms of tracking to ensure validity and accurate portal of items affiliated with the digital record of existence. Thus, in one version of the invention the audio/visual information likewise includes an indicator of authenticity, such as by being encrypted, incorporating a time/date-stamped hash value associating the video to the book or its grade, or through other means. In another example of the invention, an encrypted code can be incorporated into the video. The encryption key can be retained by the owner of the collectible item or another trusted party, enabling the owner to verify the authenticity of the video by decrypting the code.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A system for viewing a sealed collectible item stored within a protective case, comprising:
a visual file stored separately from the protective case, the visual file containing one or more images of an interior of the sealed collectible item; and
a label visible on the protective case, the label containing instructions directing a user to the visual file.

2. The system of claim 1, wherein the label comprises a scannable label.

3. The system of claim 2, further comprising an application program stored on a mobile device, the application program being configured to scan the scannable label under operation of the user and to automatically connect the mobile device to a remote server containing the visual file.

4. The system of claim 2, wherein the scannable label comprises a bar code.

5. The system of claim 2, wherein the scannable label comprises a textual code.

6. The system of claim 2, wherein the scannable label comprises a QR code.

7. The system of claim 1, wherein the visual file comprises still images of the collectible item.

8. The system of claim 1, wherein the visual file comprises video images of the collectible item.

9. The system of claim 1, where in the visual file comprises audio images accompanying the visual images.

10. The system of claim 1, wherein the visual file comprises an image of the sealed collectible item in the protective case accompanying the images of the interior of the collectible item.

11. The system of claim 1, wherein the visual file further comprises a grade for the collectible item

12. The system of claim 11, wherein the visual file is stored on a remote server computer.

13. The system of claim 12, wherein the remote server computer further comprises programming instructions operable by the remote server computer inviting the user to submit a grade for the collectible item.

14. The system of claim 13, wherein the remote server further comprises programming instructions operable by the remote server computer to aggregate grades for the collectible item from a plurality of users, and to present the aggregated grade with the visual file.

15. A system for viewing a sealed collectible item stored within a protective case, comprising:
an audio/visual file stored separately from the protective case, the audio/visual file containing one or more images of an interior of the sealed collectible item; and
a label visible on the protective case, the label providing a means for access to the audio/visual file.

16. The system of claim 16, wherein the audio/visual file comprises an index linking the index to particular pages of the collectible item within the audio/visual file.

17. The system of claim 16, wherein the audio/visual file comprises a time stamp indicating the date on which the audio/visual file was created.

18. The system of claim 16, wherein the means for access to the audio/visual file comprises a means for automatically connecting a user to the audio/visual file.

19. The system of claim 19, wherein the means for automatically connecting the user is triggered by scanning a code contained on the protective case.
